(19) United States
(12) Patent Application Publication
(10) Pub. No.: US 2014/0090036 A1
(43) Pub. Date: Mar. 27, 2014

(54) ONLINE CREDENTIAL PLATFORM

(71) Applicant: SIGKAT CORPORATION, Vienna, VA (US)

(72) Inventor: Jay Benson ROBERTS, Silver Spring, MD (US)

(73) Assignee: SIGKAT CORPORATION, Vienna, VA (US)

(21) Appl. No.: 14/036,891

(22) Filed: Sep. 25, 2013

Related U.S. Application Data
(60) Provisional application No. 61/705,430, filed on Sep. 25, 2012.

(51) Int. Cl. H04L 29/06

(52) U.S. Cl. CPC H04L 63/08
USPC 726/6

(57) ABSTRACT

An online credential platform enables organizations and people to create, manage, exchange and verify professional and personal credentials to support trust, reputation and transactions. The platform can allow credential issuers to create credential types and then assign them to proxies that represent real world persons or entities. Following this, it can allow other sites and applications to verify a person's or entity's credentials within the scope of their site or application reliably and with maximum privacy/anonymity.

### CROSS REFERENCE TO RELATED APPLICATIONS

This application claims the benefit of U.S. Provisional Patent Application No. 61/705,430, filed Sep. 25, 2012, the entirety of which is incorporated herein by reference.

### FIELD OF THE DISCLOSURE

This relates to credential management, including creating, managing, exchanging and verifying professional and personal credentials to support trust, reputation and transactions.

### BACKGROUND

A credential can be an attestation of qualification, competence, authority, achievement, personal quality, access, or other aspect of a person's background, which has been issued to an individual or organization (“Credential Holder) by a third party with a relevant or de facto authority or assumed competence to do so (”Credential Authority“), which then can be used to indicate to another party (”Credential Consumer') that they are suitable or qualified for something. For example, credentials can be: formal or informal; institutional or personal; professionally critical or incidental; and range from established credentials like degrees, certifications, memberships, work-history, etc., to emerging credentials like web reputation scores, e-learning badges, or things that are not currently considered to be credentials.

In many areas of professional and personal life the issuance, exchange and validation of credentials is an analog process, done much the same way as it was done for 100's of years, e.g., a recognized institution creates various credentials which may be earned through education and passing tests. Upon doing so, the awardee would be granted the credential, usually memorialized by a paper certificate. Third parties could verify that person's credentials either by obtaining the original or a certified copy of the certificate from the Holder or the Authority.

Some industries have replaced or augmented this paper-based process and record and verify credentials via one or more authoritative databases. Two examples, the health care and employment market, are described below.

The credentialing ecosystem in the health care market is mature and complex. It has numerous governmental, non-profit and commercial organizations and people involved in various parts of the credentialing process, including medical professionals and institutions that: earn and receive certifications and accreditations (e.g., hospitals, clinics, practices, insurers, medical professionals); license and certify organizations (e.g., state licensing boards, professional associations); verification organizations; and credentialing certification governance and regulation organizations (e.g., URAC and NCQA).

Generally, medical practitioners and institutions must regularly renew and collect all of their various accreditations, licenses, degrees, etc., and then re-distribute these multiple credentials to the various organizations that require them. Often these processes are paper-based and vary depending on the institution, the location, local governing regulations, etc. Because of the complexity and these variations, there are large numbers of third-party service providers who provide software and services to assist the organizations that need to collect, assess and manage credentials.

Last, there are a number of Credential Verification Organizations (“CVOs”) that set standards and other practices for organizations involved in the medical credentialing process, including practices and requirements related to the credentialing and re-credentialing verification by the credential service providers. Some of these CVOs maintain industry certified authoritative databases to assist in the collection and re-distribution of certain sets of credential information among Issuers, Holders and Verifiers.

One CVO, the Council for Affordable Quality Healthcare (“CAQH”), for example, is a non-profit alliance of health plans and trade associations, working to simplify healthcare administration through industry collaboration, in part, to reduce costs from healthcare administration and facilitate administrative healthcare information exchange. CAQH maintains the Universal Credentialing Datasource (“UCD”). The UCD is built around a single electronic form and database, which enables healthcare providers to submit, store, update and access their most critical information for credentialing, claims processing, quality assurance and member services, such as directories and referrals. Health plans authorized by providers participating in UCD can electronically download the information into their systems.

Like the credentialing ecosystem in the health care market, the employment verification industry is mature, distributed and largely paper driven. It appears that though much of this workforce verification is done by hand, even though much of it is done against existing large commercial and government databases. Also, as with the health care market, there are a large number of service providers who are acting on behalf of the ultimate “credential consumers” (the employers) to assist them in verifying the status and credentials of prospective/current employees. There appears to be a large number of companies that provide a broad suite of verification services for prospective employers.

Depending on the industry, the types of verifications and checks that are available run the gamut, including:
SSN verifications/traces, along with addresses, names, etc.;
Motor Vehicle checks, including infractions, accidents, etc.
I-9 verifications
Consumer credit reports (often via the big credit report players)
Local, state, federal, terrorist and international criminal checks
Professional and education history verifications
Professional license verifications
Professional reference checks
Court, bankruptcy, lien, etc. searches

Despite the many service providers, it still appears that most of the players go about providing these services in the same way: a consultant will check against other third-party databases (a number of which may have access costs), research other records, make phone calls, obtain paper records.

### SUMMARY

In order for professional and personal credentials to be truly useful they should be provided in a way that ensures transparency, trust and user control. The value and usefulness of credentials can be diminished by the time, expense and unreliability involved in sharing and verifying them. What's been missing is a simple, reliable way for anyone to create, receive, share and validate credentials online.

An online credential platform is disclosed that provides enabling technology to make the online creation and exchange of credentials fast, transparent and trustworthy at little or no cost, so much so that anyone can create and issue any type of established or new credentials to anyone, which credentials alone or in combination can, in turn, be readily exchanged among, and used by, Issuers, Holders and Consumers to support an infinitely expanding range of transactions.

Through this online credential platform, a credential issuer, such as a private company, association, academic institution, or individual can create credential types and issue instances of them to credentialees such as private companies, associations, academic institutions, or individuals.

Issuers can assign credentials directly to a proxy representing the credentialee such as the credentialee's account in the online credential platform or a placeholder proxy identified by a key that uniquely identifies and is verifiable by the credentialee and is known to the issuer. Examples of keys can include single value keys such as email address, phone number, unique id of a user account at a website, a unique id assigned by the issuer, SSN, or Open Id account and multiple value keys such as name/address.

Proxies, and the credentials assigned to them (or that will be assigned to them) can be claimed by the credentialee by verifying the credentialee's access and/or control of the proxy information to the satisfaction of the online credential platform. Credentials can be assigned to any proxy that has been verified/claimed by a credentialee, and credentials can be also be assigned to any proxy that the issuer asserts exists, before any credentialee has verified/claimed the proxy.

The credentials held by the credentialee can be widely portable online for purposes of display, discovery by others, and for presentation to third party consumers online. Credentials can be represented as issued to the actual credentialee or the proxy to which they are assigned. Credentials issued to one proxy verified by a credentialee can also be represented via another verified proxy held by the same credentialee. For example, a credentialee can display/use multiple credentials which have been assigned to the credentialee via different proxies that the credentialee controls.

Further, third party consumers of credentials can verify online that a specific credential or combination of credentials are held by a credentialee in a manner that is secure and respects the privacy of the credentialee. An advantage of the online credential platform is that it allows a site/application operator to have an anonymous visitor to the operator's site (not a registered user or such) securely certify that the visitor possesses various credentials that the site operator may be interested in, but at the same time the visitor need not give up any privacy, personally identifying information, etc., about himself/herself (other than the visitor possesses certain credential(s)).

### BRIEF DESCRIPTION OF THE DRAWINGS

FIG. 1 illustrates an example of an online credential platform architecture.

FIG. 2 illustrates an example of credential components in an online credential platform.

FIG. 3 illustrates an example of a credential assignment process in an online credential platform.

FIG. 4 illustrates an example of a credential verification process in an online credential platform.

FIGS. 5-9 illustrate examples of a user interface of an online credential verification process.

FIG. 10 is a block diagram of an example of a computing device.

### DETAILED DESCRIPTION

The present disclosure is directed to an online credential platform that can create, manage, exchange and verify professional and personal credentials to support trust, reputation and transactions. Although the embodiments disclosed herein describe professional credentials created and managed with respect to individuals, the online credential platform is not so limited and can also create and manage any type of credential with respect to any type of entity in accordance with the teachings of the present disclosure. For example, the online credential platform can award credentials to anything that is uniquely identifiable, such as a brand/vintage of wine, and that has a confirmable proxy.

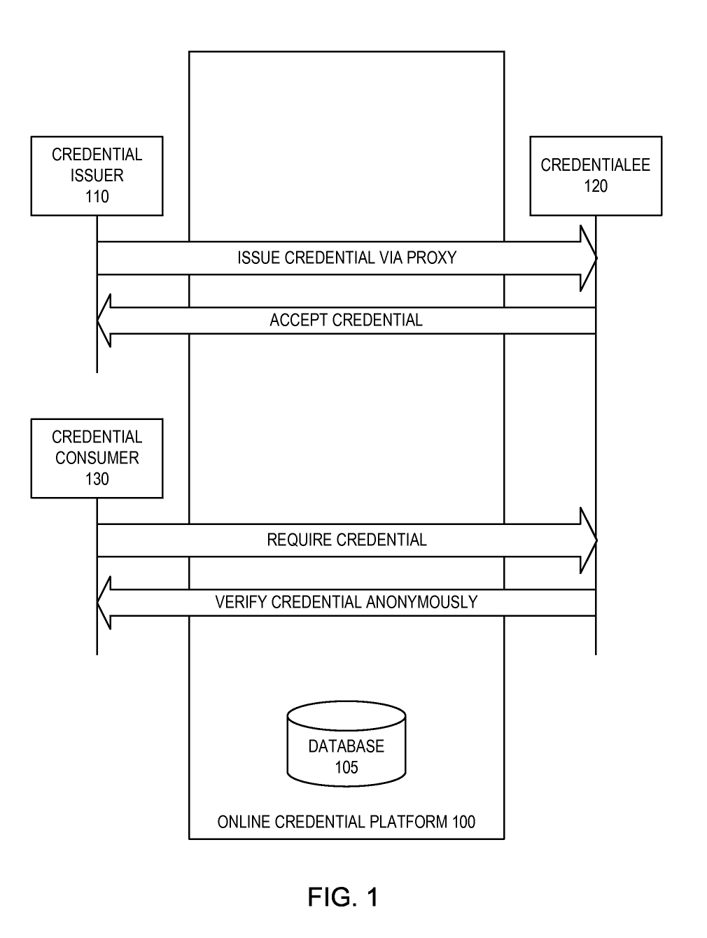

FIG. 1 illustrates an example of an online credential platform architecture. In the illustrated embodiment, online credential platform 100 can comprise one or more processors deploying a web site or other online environment accessible via a network. Online credential platform 100 can comprise database 105 for storing data pertaining to the operation of online credential platform 100, such as credential and account data.

Online credential platform 100 is accessible via a network to credential issuer 110, credentialee 120 and credential consumer 130. Credential issuer 110 can comprise a computing device operated by a credential issuer, such as a person or organization, like a school, membership organization, club, certifying body, etc., that can create, manage, issue and control its credentials and badges. Credentialee 120 can comprise a computing device operated by a credentialee or credential holder such as an individuals or organization that receives and claims its credentials, and, in turn, can share them publicly or privately with others. Credential consumer 130 can comprise a computing device operated by a credential consumer or verifier such as an individuals or organization that is granted access to verify, assure and/or transact with people based on receiving certified credentials.

As shown in FIG. 1, online credential platform 100 can enable credential issuer 110 to issue a credential to credentialee 120, and credentialee 120 to accept it, via a proxy (e.g., a parseable identifier that credentialee 120 can securely verify to use). Online credential platform 100 can also enable credential consumer 130 to require a credential that credentialee 120 can verify anonymously.

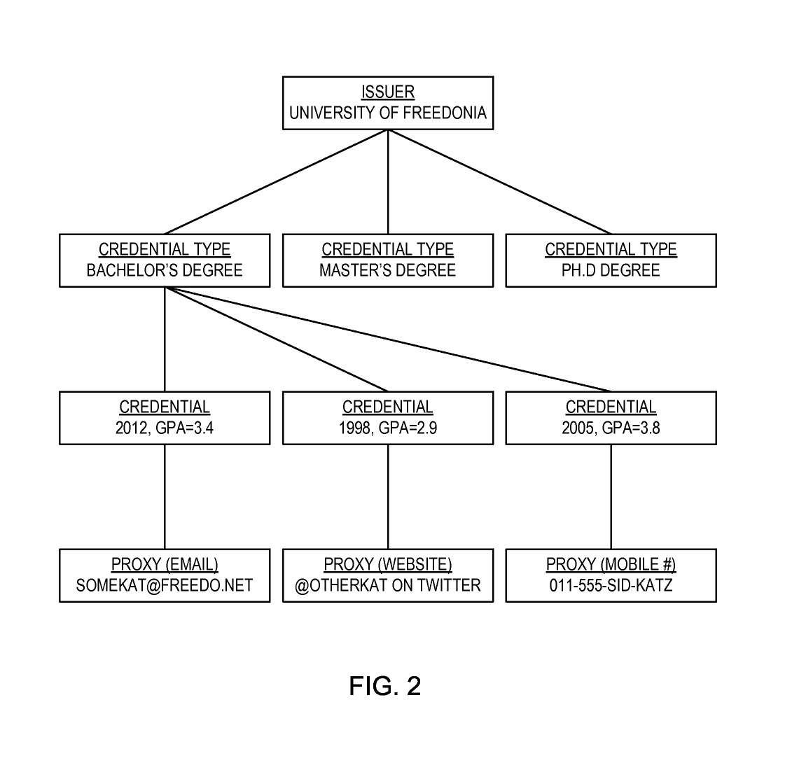

FIG. 2 illustrates an example of credential components in an online credential platform. For example, Credential Types can define the Credentials that Issuers award. A Credential Type can contain such information as the title and prerequisites of a Credential. Each Issuer can create one or more Credential Types. A Credential can be an instance of an award of a Credential Type to a specific Credentialee. It can contain information unique to that specific award of the credential, such as award and expiration dates. A Credential Certificate can comprise the visual representation of the credential and all of the metadata related to it and can serve to verify the provenance of the credential. A badge can comprise a small, iconic, online representation of the credential. Online credential platform 100 can enable users to securely exchange and display their badges on the web and in other ways. By clicking on a badge, viewers can be securely presented with the user's credential certificate. A Proxy can be one or several identifier keys for a Credentialee that are known to or issued by the Issuer and verifiable by the Credentialee.

Regarding the proxy, for example, a credentialee may have multiple different identities or personae. For example, a credentialee's employer may associate with the credentialee by the credentialee's formal name and work email address. The credentialee may belong to one or more associations that associate with the credentialee by the credentialee's nickname and personal email address/es. The credentialee may belong to multiple community websites and have signed up with different usernames and email addresses all together. However, in all cases, each of these different identifiers refer to the same entity: the credentialee. Online credential platform 100 allows the credentialee to receive credentials from all of these different issuers, via a host of these different identifiers which are called proxies in the context of the present disclosure. Online credential platform 100 allows the credentialee to securely claim each of the credentialee's proxies and the credentials associated with each of them, and manage them centrally through the credentialee's single account (should the credentialee choose to register with online credential platform 100).

In the example illustrated in FIG. 2, a Credentialee identified by the email address somekat@freedo.net was awarded a Bachelor's Degree in 2012 by the University of Freedonia with a GPA of 3.4. Other Proxy examples above include a Twitter account and a mobile account.

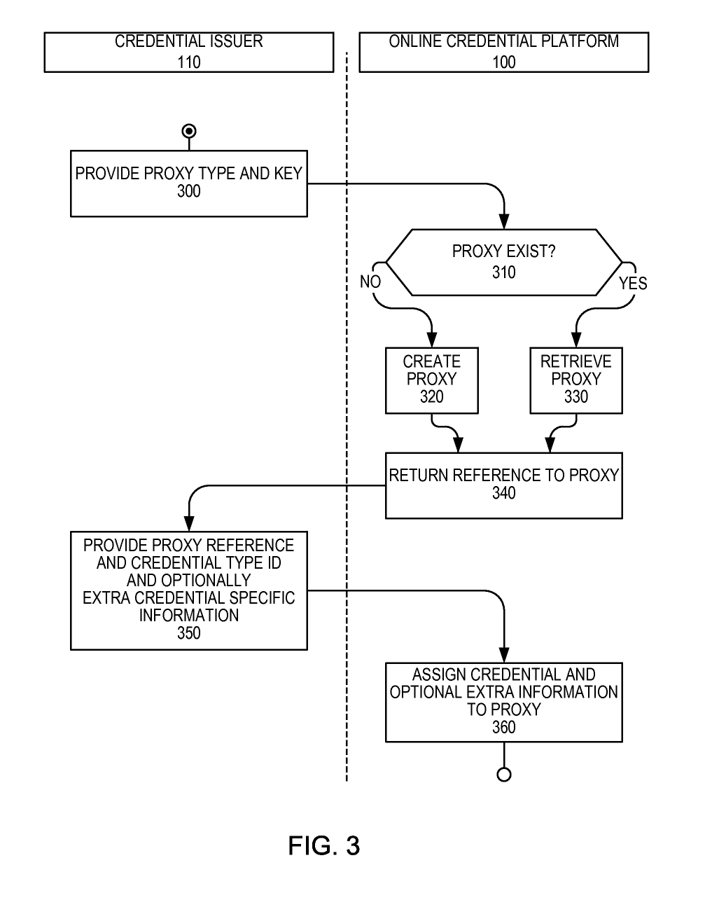

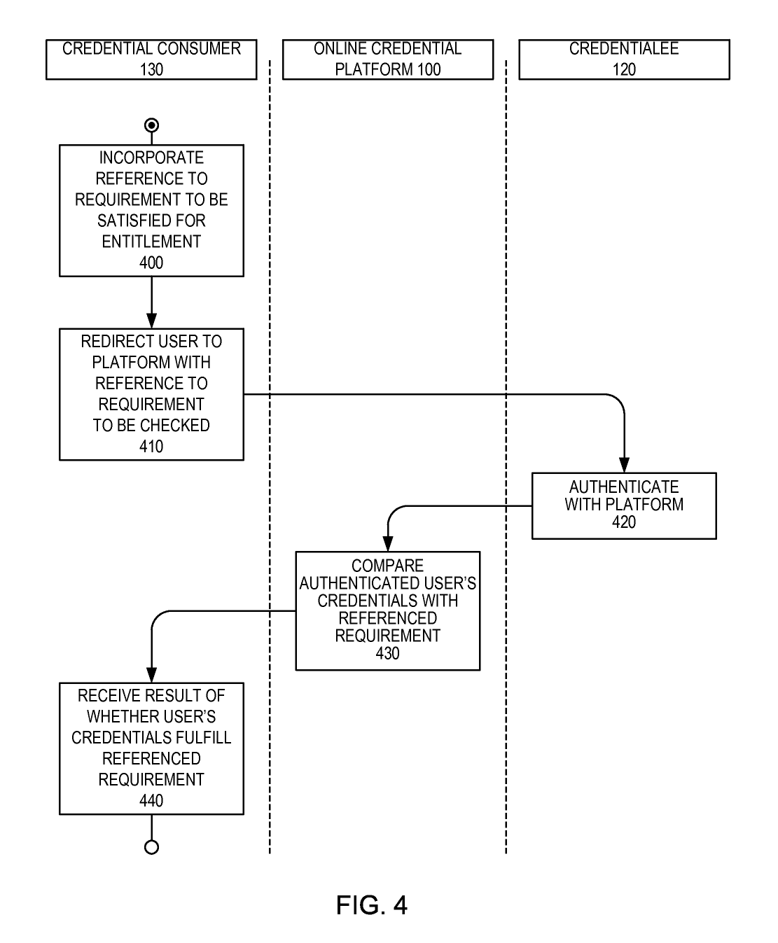

Online credential platform 100 can allow credential issuers to create credential “types” and then assign them to proxies that represent real world persons or entities, as shown for example in FIG. 3. Following this, it can allow other sites and applications to verify a person's or entity's credentials within the scope of their site or application reliably and with maximum privacy/anonymity, as shown for example in FIG. 4.

An issuer can create one or many credential types with online credential platform 100. These can be descriptors for a credential containing things such as title, description, icon, references for evidence, back links to issuer, and user defined properties that may be specific to the type or domain of the credential.

A credential can then be assigned to a proxy that is known both to the issuer and the credentialee. A proxy can be something relatively public, like email address, identity/membership in social media or other applications like eBay, to things that may be relatively private, such as mobile phone number or a private membership id on a website.

Any proxy can be usable for assigning credential if it has two properties. The first is that it uniquely identifies the credentialee. The second is that the credentialee can verify to online credential platform 100 that the credentialee controls the proxy.

Examples of verifying control of a proxy can include:
Email verification loop conducted via online credential platform 100
login to a third party website member account via online credential platform 100 (e.g., via OAuth or native API of the third party website)
Taking a cell call from online credential platform 100 and providing back to the system a provided UID
Using a custom secure identifier known only to Issuer and Credentialee, the Issuer can signal success or failure back to online credential platform 100 on a callback verification of a proxy.

The use of proxies can allow asynchronous assignment of credentials; a credentialee need not be a part or member of online credential platform 100 system at time of assignment or even at verification of credential.

In the embodiment shown in FIG. 3, credential issuer 110 can provide online credential platform 100 with a type of proxy and its key (block 300). Online credential platform 100 can determine if the proxy exists in database 105 (block 310), and retrieve the proxy if it exists (block 330) or create the proxy if it does not exist (block 320). A reference to the proxy can then be returned to credential issuer 110 (block 340). Credential issuer 110 can subsequently provide online credential platform 100 with the proxy reference and an identifier for one of the issuer's credential types maintained in online credential platform 100 and possibly extra credential specific information (block 350). Online credential platform 100 can then assign the credential and optional extra Information to the proxy (block 360).

FIG. 4 illustrates an example of a credential verification process in an online credential platform. To verify a credential, a “consumer” can create a credential requirement. This can refer to one or many credentials. In the case of many credentials, the requirement can be a Boolean product, e.g., a BS or a BA degree. Online credential platform 100 can allow creation of complex logical structures of credentials in a requirement.

When the credential is to be verified in a third party app or site, the credentialee can be directed to the online credential platform 100 system along with a reference to a requirement to be verified. Online credential platform 100 can examine and verify the credentialee's proxy(s) for the requirement and signal back to the third party app/site whether the credentialee satisfies the requirement. By default, this can be a simple yes/no and provide no information about partial fulfillment of the requirement unless the credentialee wishes to share that information.

In the embodiment shown in FIG. 4, credential consumer 130 (e.g., a consumer website or application) can contain a reference (block 400) to a credential requirement that a site visitor or user must satisfy to be granted an entitlement such as a privilege, benefit, action, discount, etc. Credentialee 120 (e.g., as a visitor/user of credential consumer 130) can be redirected by credential consumer 130 to online credential platform 100 with a reference to the requirement to be checked (block 410). Credentialee 120 can authenticate with online credential platform 100 (block 420), which can compare the authenticated user's credentials with the referenced requirement (block 430). Online credential platform 100 can signal querying credential consumer 130 such as via a callback a negative or affirmative response as to whether credentialee 120's credentials fulfill credential consumer 130's reference requirement (block 440).

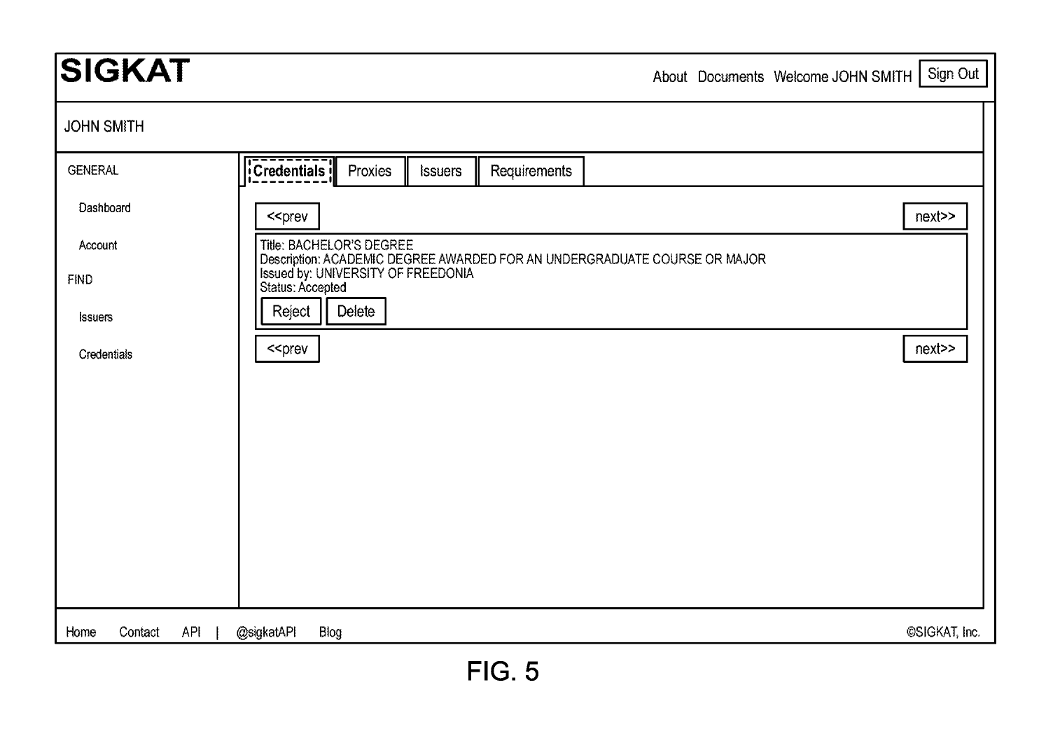

FIGS. 5-9 illustrate examples of a user interface of an online credential verification process with respect to a fictitious user John Smith who holds both a credential and works on behalf of University of Freedonia to issue credentials in online credential platform 100.

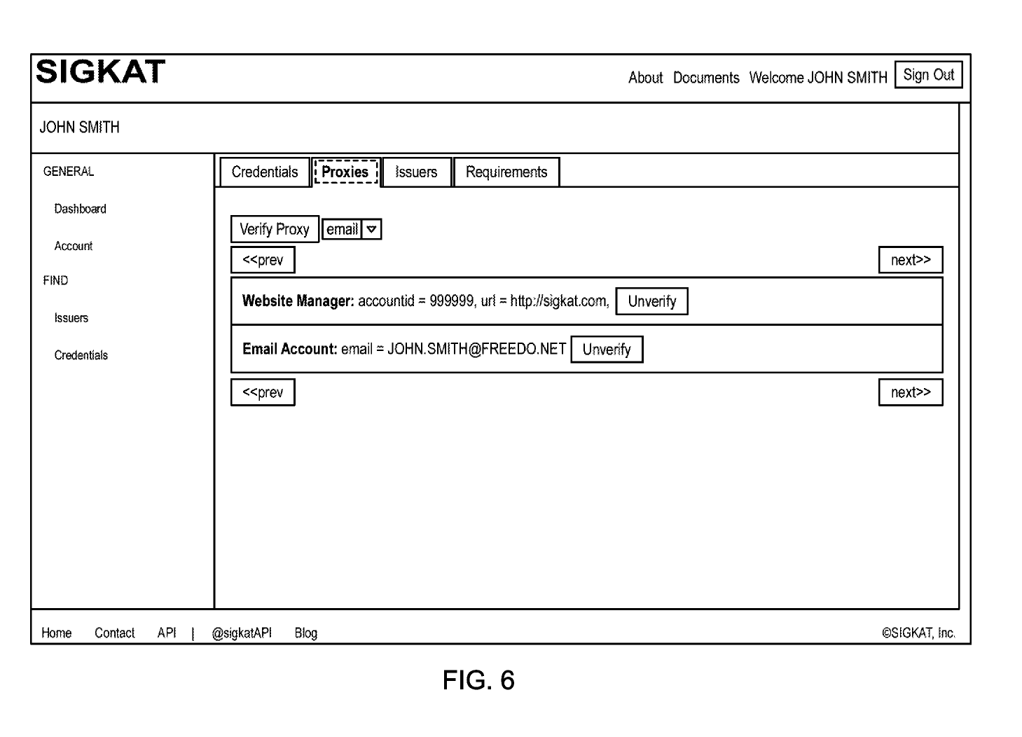

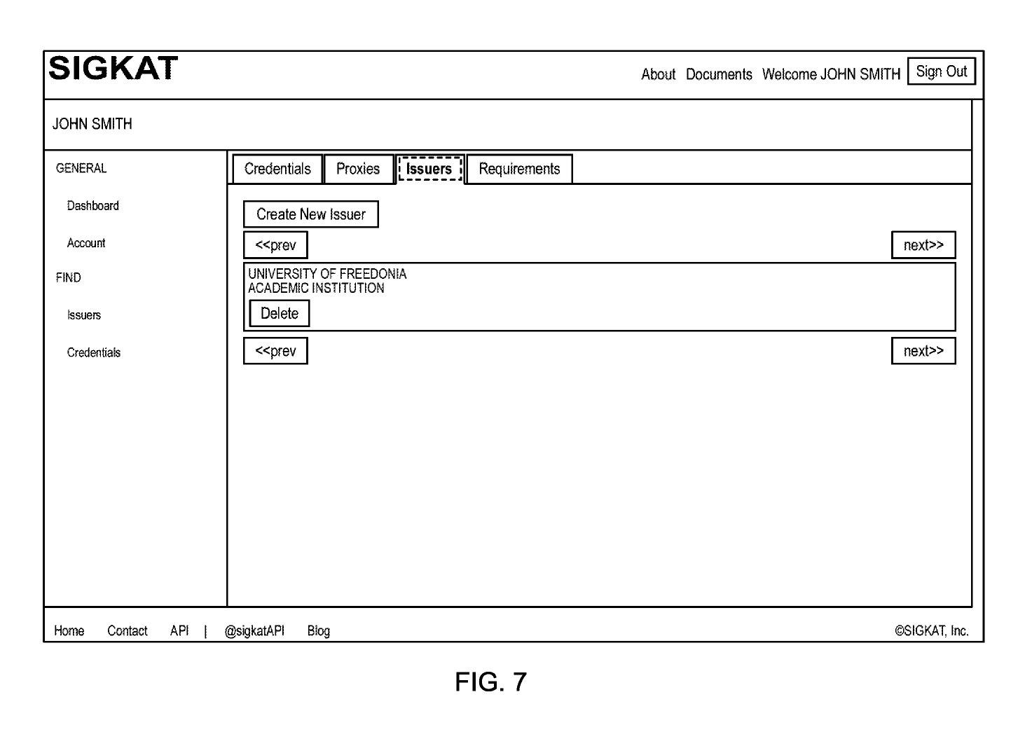

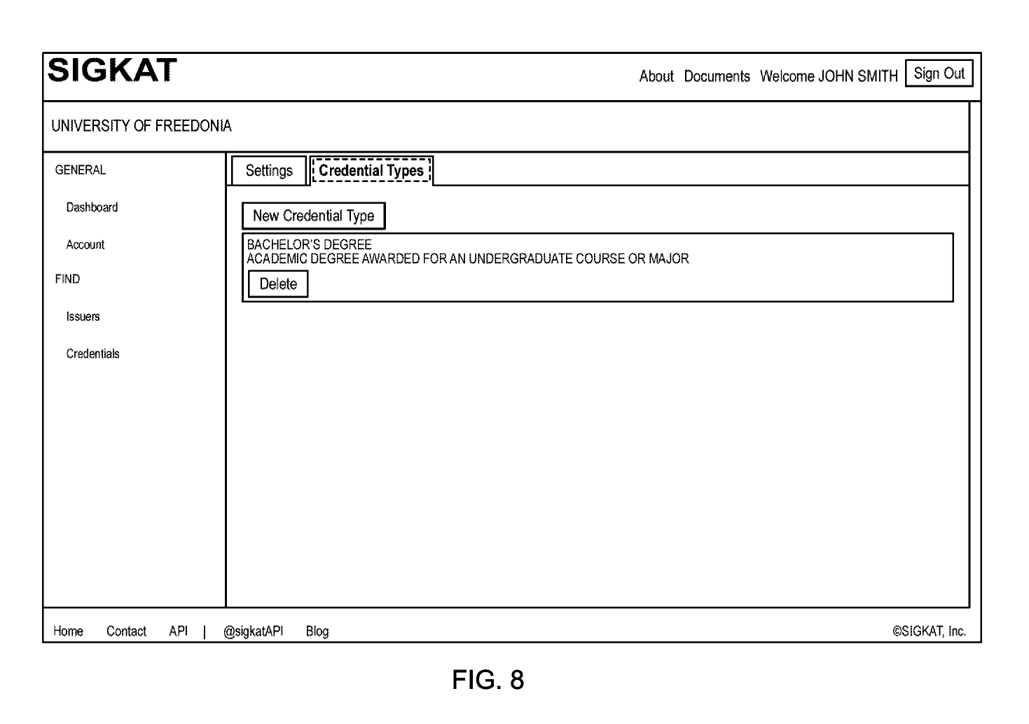

In FIG. 5 the “Credentials” tab of John Smith's account indicates that he has accepted a Bachelor's Degree credential issued by the University of Freedonia. In FIG. 6 the “Proxies” tab of John Smith's account indicates that he has two proxies—his work e-mail address and system account number—that can be used as a basis for credentials to be issued to him via online credential platform 100. In FIG. 7 the “Issuers” tab of John Smith's account indicates that he has created the University of Freedonia issuer and can issue/grant credentials on behalf of University of Freedonia. Clicking the “University of Freedonia” text can bring up the University of Freedonia page shown in FIG. 8.

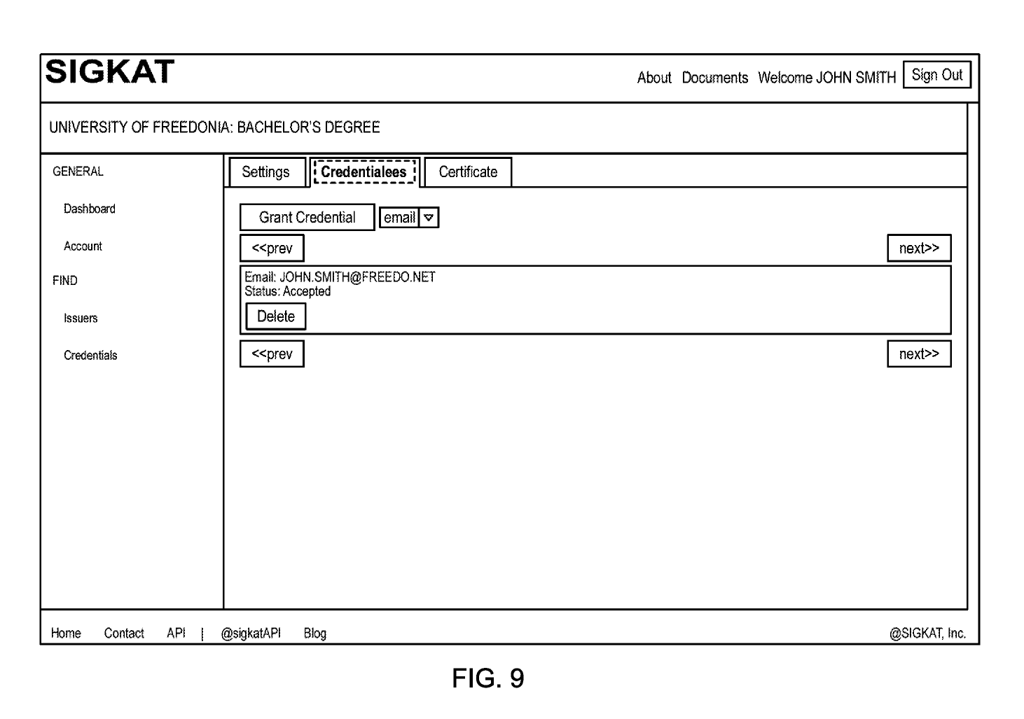

In FIG. 8 the “Credential Types” tab indicates that John Smith has created the Bachelor's Degree credential type, and a new credential type for the University of Freedonia can be created by clicking on the “New Credential Type” tab title which will bring up a page that allows John Smith to enter a title and description for the new credential type. Clicking the “Bachelor's Degree” text on the page shown in FIG. 8 will bring up the Bachelor's Degree page shown in FIG. 9 which allows John Smith, on the “Credentialees” tab, to grant credentials of the Bachelor's Degree type to a proxy. Clicking the “Grant Credential” button can bring up a page that allows John Smith to enter proxy information (e.g., an e-mail address) for a credentialee and any other data to be part of this particular credential to be issued.

Once the proxy and possibly other information is entered, online credential platform 100 can notify the credentialee (e.g., via e-mail) of the pending credential status. When the credentialee verifies the proxy, the credentialee can be shown a screen similar to that shown in FIG. 5, except the credential shown would indicate a status of “pending” and include an additional button to “accept” the credential.

Online credential platform 100 can provide an application programming interface (“API”) to enable a series of calls between online credential platform 100 and credential issuer 110′s data store that enables the creation, award and real-time exchange of credentials. Whether a user is a Credential Issuer or Consumer, the API allows the user to embed all or selected parts of online credential platform 100's credentialing functionality within the user's site and data structure. Issuers can create, manage and grant credentials via their site or application; Credentialees can claim and manage their credentials from the Issuer's site; and Consumers/Verifiers can review, accept and establish eligibility for transactions, classes, discounts, etc. from their site.

As an example, in a basic implementation, online credential platform 100 can enable an Issuer to:
Create Issuer Account and Credential Types
Award credential types to existing and new users in the Issuer's data store
Embed and display user credential badges on its website.

In this example credential issuer 110 also acts in the role of credential consumer 130. For example, once an Issuer account as well as at least one credential type has been created, credential issuer 110 can use the API to programmatically assign the credential to credential issuer 110's members via credential issuer 110's site and data store—globally to all existing members, and as needed as credential issuer 110 awards credentials to new members. In this example credential issuer 110 can grant its credential to all its members via an Issuer generated user proxy.

Once credential issuer 110 has issued credentials to credential issuer 110's members/users, credential issuer 110 can use the API to programmatically embed Credential Badges next to their names where they appear on various pages on credential issuer 110's site, such as directory pages or member profile pages. A security feature for Badge placements, which can prevent Badges from being “hijacked” by third-parties, can be that credential issuer 110 needs to identify the web site(s) where the Badges are permitted to appear. This can prevent third-parties from “hijacking” Badges and displaying them in other locations for other people.

Many users can have multiple roles in the credential chain, issuing, receiving and consuming credentials in multiple different ways.

Credential holders can also collect credentials from multiple issuers. A credential holder can receive credentials from an unlimited number of different Issuers, each of whom may associate with the credential holder via a different professional or personal web identity, such as the credential holder's personal or work email addresses, membership numbers, etc. The credential holder can manage the credentials associated with each of these personal proxies or identities from a single account.

Once a credential holder has claimed the credential holder's credentials, the credential holder can share one or more of them publicly or privately online in a number of different ways. For example, the credential holder can use the online credential platform 100's Badge Widget to place a credential badge on one or more blogs, social sites, or other websites. The credential holder can also privately grant access to a specific credential to one or more people via email, for example.

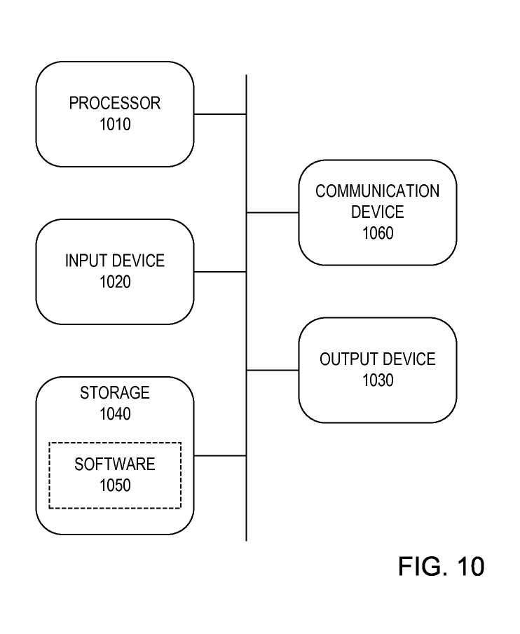

FIG. 10 shows a block diagram of an example of a computing device, which may generally correspond to online credential platform 100, credential issuer 110, credentialee 120 and credential consumer 130. The form of computing device 1000 may be widely varied. For example, computing device 1000 can be a personal computer, workstation, server, handheld computing device, or any other suitable type of microprocessor-based device. Computing device 1000 can include, for example, one or more components including processor 1010, input device 1020, output device 1030, storage 1040, and communication device 1060. These components may be widely varied, and can be connected to each other in any suitable manner, such as via a physical bus, network line or wirelessly for example.

For example, input device 1020 may include a keyboard, mouse, touch screen or monitor, voice-recognition device, or any other suitable device that provides input. Output device 1030 may include, for example, a monitor, printer, disk drive, speakers, or any other suitable device that provides output.

Storage 1040 may include volatile and/or nonvolatile data storage, such as one or more electrical, magnetic or optical memories such as a RAM, cache, hard drive, CD-ROM drive, tape drive or removable storage disk for example. Communication device 1060 may include, for example, a network interface card, modem or any other suitable device capable of transmitting and receiving signals over a network.

The network (not shown) may include any suitable interconnected communication system, such as a local area network (LAN) or wide area network (WAN) for example. The network may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1050 can be stored in storage 1040 and executed by processor 1010, and may include, for example, programming that embodies the functionality described in the various embodiments of the present disclosure. The programming may take any suitable form. Software 1050 may include, for example, a combination of servers such as application servers and database servers.

Software 1050 can also be stored and/or transported within any computer-readable storage medium for use by or in connection with an instruction execution system, apparatus, or device, such as computing device 1000 for example, that can fetch instructions associated with the software from the instruction execution system, apparatus, or device and execute the instructions. In the context of this document, a computer-readable storage medium can be any medium, such as storage 1040 for example, that can contain or store programming for use by or in connection with an instruction execution system, apparatus, or device.

Software 1050 can also be propagated within any transport medium for use by or in connection with an instruction execution system, apparatus, or device, such as computing device 1000 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An online credential platform comprising one or more processors configured to:
receive from a first entity a request to issue a credential to a proxy associated with a second entity; and
assign the credential to the proxy in response to the request to issue the credential.

2. The online credential platform of claim 1, wherein the proxy comprises one or more identifier keys for the second entity.

3. The online credential platform of claim 2, wherein the one or more identifier keys uniquely identify the second entity.

4. The online credential platform of claim 2, wherein the one or more identifier keys are verifiable by the second entity.

5. The online credential platform of claim 1, comprising one or more processors configured to
receive from the second entity an indication that the second entity controls the proxy.

6. The online credential platform of claim 5, wherein the indication comprises an e-mail verification loop conducted via the online credential platform.

7. The online credential platform of claim 5, wherein the indication comprises a login to a third party website member account via the online credential platform.

8. The online credential platform of claim 5, wherein the indication comprises a user identifier previously provided to a mobile device of the second entity by the online credential platform.

9. The online credential platform of claim 1, comprising one or more processors configured to
receive from the first entity an indication that the second entity controls the proxy.

10. The online credential platform of claim 9, wherein the indication signals success or failure on a callback verification of the proxy using a custom secure identifier intended to be known only to the first entity and the second entity.

11. The online credential platform of claim 1, wherein the second entity is not registered with the online credential platform at time of assignment of the credential.

12. The online credential platform of claim 2, wherein the proxy comprises an e-mail address of the second entity.

13. The online credential platform of claim 2, wherein the proxy comprises a third party website member account identifier of the second entity.

14. The online credential platform of claim 2, wherein the proxy comprises a mobile number of the second entity.

15. The online credential platform of claim 1, comprising one or more processors configured to
receive from the first entity a request to define the credential; and
generate the credential in response to the request to define the credential.

16. The online credential platform of claim 2, wherein the request to define the credential comprises one or more of a title and a description of the credential.

17. A method comprising:
receiving, by an online credential platform, a request from a first entity to create a credential requirement comprising one or more credentials associated with the online credential platform;
creating, by the online credential platform, the credential requirement in response to the request; and
returning, by the online credential platform, a reference to the credential requirement to first entity.

18. The method of claim 17, wherein the request comprises a Boolean product of multiple credentials associated with the online credential platform.

19. The method of claim 17 comprising comparing one or more credentials associated with a second entity with the credential requirement and verifying that the second entity meets the credential requirement of the first entity based on the comparison.

20. The method of claim 19, wherein the second entity is not registered with the online credential platform at time of verification of the credential.
